(19) United States
(12) Patent Application Publication
(10) Pub. No.: US 2005/0047561 A1
(43) Pub. Date: Mar. 3, 2005

(54) Advanced method and system for handling missed mobile calls

(76) Inventor: Frank Seiferth, Crimmitschau (DE)

Correspondence Address: REDKNEE INC., 2560 MATHESON BLVD. EAST, SUITE 500, MISSISSAUGA, ON, L4W4W9, CA

(21) Appl. No.: 10/448,286

(22) Filed: Aug. 27, 2003

(51) Int. Cl. H04M 1/64

(52) U.S. Cl. 379/88.22; 455/414.1

(57) ABSTRACT

The advanced method and system for handling missed mobile calls represents a progress in the art which allows wireless subscribers to be notified by any addressable, asynchronous delivery mechanism, including Short Message Service (SMS), Multimedia Messaging Service (MMS) and E-mail among others, when incoming telecommunications are missed as when they are otherwise unreachable (for instance, when the wireless device is turned off or outside coverage area) or busy. The notification would include the Calling Party Number, among other configurable variables, as to enable subscribers to the service to subsequently return the call to the originating party.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND ART

Traditionally, mobile phones, wireless devices and other related instruments of said telephony have provided users a “missed call” feature or indicator which tracks and notifies said subscribers of their lost phone calls in a relatively non-intrusive, user-friendly manner. However, to receive “missed call” notifications as this, subscribers' mobile devices must be turned on, be within coverage area of the home network (or a roaming partner), disable the Call Forward Unconditional (CFU) feature (or ensure that it is not enabled in the first instance), among other such functional requirements. Needless to say, there remains some deficiency in the state of the art.

Voice mail, of course, also tracks and notifies subscribers of messages, but since it requires access codes, and remains largely aural (and not visual), subscribers often ignore voice mail notifications simply because they do not have enough information to justify checking messages and, consequently, returning missed calls with any expediency.

Indeed, the advanced method and system for handling missed mobile calls detailed herein, offers, inter alia, new notification services to mobile subscribers without necessarily using existing voice mail (and related technologies or services), while in parallel, also introducing significant potential to enhance current voice mail service offerings.

State of the art teachings, as with U.S. Pat. No. 6,496,691 to Easley, L. et al. entitled Enhanced call return in a wireless telephone network, details a method for enabling enhanced call return in a wireless network comprising receiving an incoming telephone call from a caller, wherein the incoming telephone call identifies a mobile subscriber (MS) as a caller thereof; capturing caller-specific information for the caller, wherein the caller-specific information includes at least one of the name of the caller and the telephone number of the caller; and storing the caller-specific information into an intelligent peripheral (IP) within the wireless network, inter alia.

However, the elements thereof remain tied and specific to networks which utilize IS-41 networks while the invention of present seeking the protection of Letters Patent, can be extended to networks which use Intelligent Network (IN) technologies generally. Still into the bargain, the Easley et al.'s patent requires modifications to existing network infrastructure including the HLR as opposed to the art of present which does not require any such modifications to existing network infrastructure.

Penultimately, WIPO Patent No. 02052881 to Bizzi, M. et al., entitled Method and device for handling telephone calls directed to non-reachable mobile phones, delimits a method for handling telephone calls directed to a non-reachable mobile phone, and for handling data pertaining to them, wherein: (I)—provided the call diversion service to a different number, or the answering service, have not been enabled, the phone call is routed towards a phone call data management and storage device, when the mobile phone called user is non-reachable, due to the fact that is in the detach mode or is temporarily out of the range reachable by radio-frequency signals; (II)—at the time mobile phone is again reachable, a notification is transmitted to the subscriber number of the telephone call; said notification being effected in the form of SMS, which contain phone call data of missed phone calls performed during the period while the mobile phone was not reachable. Nonetheless the inventiveness thereof remains tied to GSM/UMTS networks, and relies on the capture of calling party identification by redirect the call to an network adjunct using the ISDN User part (ISUP) protocol in tandem with Supplementary Services based on Call Forwarding (e.g. Call Forward Don't Answer). Our invention retrieves calling party information using messaging associated with Call Termination triggers allied to Intelligent Network technologies (as WIN, CS-1, CS-1R, CAMEL etc.) and indeed, employs Intelligent Network (IN) infrastructures generally.

U.S. Pat. No. 6,049,713 to Tran, H. et al. entitled System and method of providing calling-line identification (CLI) information to a mobile terminal in a radio telecommunications network represents the concluding state of the art teaching in this respect. The abstract thereof summarizes the scope of the matter protected and teaches of a system and method in a radio telecommunications network for storing calling line identification (CLI) information when a called mobile terminal is not available to receive the CLI information, and forwarding said CLI information to the called mobile terminal when the terminal becomes available. When the incoming call for the mobile terminal is received in a gateway mobile switching center (G-MSC), the Home Location Register (HLR) or the visited MSC (V-MSC) where the mobile terminal is operating determines whether the mobile terminal is available; if not, the G-MSC sends a short message service (SMS) point-to-point (PTP) message to a message center (MC) and includes the CLI information. The MC is notified when the mobile terminal becomes available. The MC then forwards the CLI information to the V-MSC in a SMS PTP message. The V-MSC sends the CLI information to the mobile terminal in an IS-136 R-DATA message or other appropriate data message.

Nonetheless, Tran, H. et al.'s patent remains specific to infrastructure(s) which utilize IS-41 networks while our invention of present, as emphasized prior, can generally and generically be implemented on infrastructure(s) which utilize IN technologies. Additionally, the patent to Tran, H. et al. requires modifications to existing network infrastructure. Specifically, the G-MSC is modified to act as a Short Message Entity for the purpose of communicating Calling Line information to the SMS-C. It has also already been underscored prior, that, central to the inventiveness of our art seeking protection, remains the fact that it does not require any such modification to existing network infrastructure.

REFERENCES CITED:

| | | | |
|---|---|---|---|
| U.S. Pat. No. 6,496,691 | December 2002 | Easley, et al. | 455/415 |
| U.S. Pat. No. 6,049,713 | April 200 | Tran, et al. | 455/415 |
| Foreign Patent Document(s) | | | |
| 02052881 | July 2002 | | WO |

### TECHNICAL FIELD

The present invention relates generally to mobile telephony services and related telecommunication network implementations; and in particular to an advanced method and system for handling missed mobile calls.

### SUMMARY OF THE INVENTION

Traditionally, mobile phones, wireless devices and other related instruments of said telephony have provided users a “missed call” feature or indicator which tracks and notifies said subscribers of their lost phone calls in a relatively non-intrusive, user-friendly manner. However, to receive “missed call” notifications as this, subscribers' mobile devices must be turned on, be within coverage area of the home network (or a roaming partner), disable the Call Forward Unconditional (CFU) feature (or ensure that it is not enabled in the first instance), among other such functional requirements. Needless to say, there remains some deficiency in the state of the art.

The advanced method and system for handling missed mobile calls seeking the protection of Letters Patent, captures and displays missed calls via any addressable, asynchronous delivery mechanism, including Short Message Service (SMS), Multimedia Messaging Service (MMS) and E-mail among others, which includes Calling Line Identification (Caller ID), date and time of last call, the number of missed calls, among other variables as permitted by the state of the art and where available. The precise information conveyed may be configured by the subscriber or network operator.

Indeed, the advanced method and system for handling missed mobile calls detailed herein, offers, inter alia, new notification services to mobile subscribers without necessarily using existing voice mail (and related technologies or services), while in parallel, introducing the potential for significant enhancements commercially and to the technical art of current voice mail services. As mobile subscribers who may already subscribe to voice mail type services would assuredly derive benefit from the art of present as it has been innovatively embedded with the logic to detect voice mail “slam-downs”, whereby the incoming caller does not leave a message and simply ‘hangs-up’ after a certain number of rings. The advanced method and system for handling missed mobile calls thereby notifies the unreachable subscriber in question by any of the addressable, asynchronous delivery mechanisms, including Short Message Service (SMS), Multimedia Messaging Service (MMS) and E-mail among others, available within the state of the art. Indeed, voice mail subscribers ordinarily receive no information in regards to these missed (“slam-down”) calls.

### BRIEF DESCRIPTION OF THE DRAWINGS

FIG. 1 details a non-limiting call-flow of the advanced method and system for handling missed mobile calls (including optional embodiments for voice-mail (VM) redirection and/or routing to a terminating announcement).

### DETAILED DESCRIPTION OF THE PREFERRED EMBODIMENTS

The advanced method and system for handling missed mobile calls represents an open architectural solution intended to provide wireless subscribers with an additional mechanism for handling incoming calls which are missed for one reason or the other.

Incoming telecommunications which terminate at the wireless handset which remain unanswered are ordinarily captured in the “missed calls” list. However, scenarios exist whereby the Calling Party Number (CPN) will not be captured in said list. Non-limiting examples of which include instances:
1. Where the subscriber's handset is turned off; or
2. Where the subscriber is located in an unreachable area; or
3. Where the subscriber has Call Forward Unconditional (CFU) enabled

On such occasions, where the caller does not leave a message in the subscriber's voice message mailbox (‘voice mail’), or if the subscriber is not subscribed to voice mail then said subscriber will not be aware that they have missed a call.

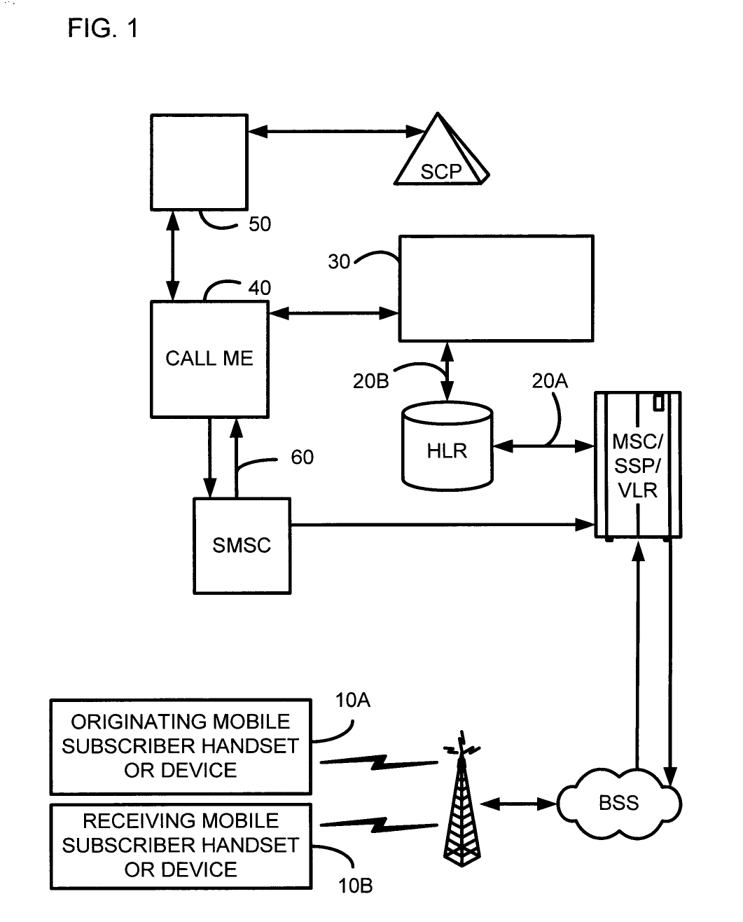

With reference now to FIG. 1, the advanced method and system for handling missed mobile calls 100 addresses such limitations in the art, since, after the calling party's 10 incoming call is redirected 200 by the HLR (not shown) (e.g. to voice mail 50 for instance), the call will encounter the DP3 trigger and the Call Control logic 100A of the advanced method and system for handling missed mobile calls 100 will extract the Calling Party Number from the InitialDP operation 210.

At 220, the logic of the advanced method and system for handling missed mobile calls is notified of a call event, and where applicable in alternate embodiments 290B, detects that the call should be eventually routed to voice mail.

The advanced method and system for handling missed mobile calls 100 subsequently sends (via the User Interaction Service 100B) an SMS message (in this instance) (via the SMS-C 60), which includes the Calling Party Number (among other information variables), to the subscriber. Members skilled in the art will recognize that any addressable, asynchronous delivery mechanism, including Short Message Service (SMS), Multimedia Messaging Service (MMS) and E-mail among others, will suffice for this purpose.

Practitioners skilled in the art will recognize that Call Control and User Interaction Service remain elements of the state of the art which are fairly well practiced/known and although they form elements of the overall architectural solution presented herewith, do not necessarily form the core inventive components of the advanced method and system for handling missed mobile calls 100.

In expanding upon earlier stated alternate embodiments, at 220, the logic of the advanced method and system for handling missed mobile calls is notified of a call event, and detects that the call should be eventually routed 290B (by means of a ‘continue operation’ or similar such logical command to the MSC SSP) to voice mail 50. In still further embodiments, a Connect (DRA=terminating announcement DN) is returned to the MSC SSP 290A, where said announcement is played and the call subsequently disconnected.

1. An advanced method and system for handling missed mobile calls.

2. The method of claim 1, which captures and displays missed calls via any addressable, asynchronous delivery mechanism and includes data and other informational variables pertaining to said call and relays it as such to the terminating party.

3. The method of claim 2, where such addressable, asynchronous delivery mechanisms include Short Message Service (SMS), Multimedia Messaging Service (MMS) and E-mail, and which nonetheless remain only limited to the state of the art.

4. The method of claim 2, wherewith such data and other informational variables include date and time of last call, the number of missed calls, Calling Line Identification (Caller ID), priority and so forth as available.

5. The method of claim 2, where missed calls refers to unanswered incoming telecommunications which terminate at the wireless handset and where the Calling Party Number (CPN) are not captured in the “missed calls” list, feature or directory.

6. The method of claim 5, wherein such events are not captured where the terminating wireless subscriber's device is turned off and/or remains in an unreachable location and/or where the Call Forward Unconditional (CFU) feature has been enabled, among other such illustrative examples from the existing state of technology.

7. The method of claim 2, where the specific addressable, asynchronous delivery mechanism(s) and/or data and other informational variables remain highly configurable as per the wireless subscriber's and/or network operator's needs and requirements.

8. The method of claim 2, whereby the advanced method and system for handling missed mobile calls exists as part of a computer program product, comprising:
a) a computer readable memory medium; and
b) a computer program including the logic required to the steps, methods and rules as such.

9. The method of claim 2, which is invoked after the incoming telecommunication is redirected by the HLR.

10. The method of claim 9, whereby the telecommunication will encounter a specified trigger in its routing, and the logic of the advanced method and system for handling missed mobile calls will extract the Calling Party Number from the representative operation.

11. The method of claim 10, which subsequently transmits a message via any addressable, asynchronous delivery mechanism (SMS for instance) to the appropriate network element (as an SMS-C for instance).

12. The method of claim 11, which includes the Calling Party Number among other such informational variables to the terminating subscriber.

13. The method of claim 2, where the logic of the advanced method and system for handling missed mobile calls is notified of a call event, and where applicable detects that the call should be eventually routed to voice mail.

14. The method of claim 13, where the call is eventually routed to voice mail by means of a ‘continue operation’ or similar such logical command to the MSC SSP.

15. The method of claim 13, where an announcement is played before the call is subsequently disconnected by transmitting a Connect (DRA=terminating announcement DN for instance) or similar such logical command to the MSC SSP.
